(19) United States
(12) Patent Application Publication
(10) Pub. No.: US 2006/0066776 A1
(43) Pub. Date: Mar. 30, 2006

(54) Liquid crystal display device

(76) Inventors: Ryuichiro Isobe, Kawasaki-shi (JP); Yasufumi Asao, Atsugi-shi (JP)

Correspondence Address: MORGAN & FINNEGAN, L.L.P., 3 WORLD FINANCIAL CENTER, NEW YORK, NY, 10281-2101, US

(21) Appl. No.: 11/231,443

(22) Filed: Sep. 20, 2005

(30) Foreign Application Priority Data
Sep. 21, 2004 (JP) 273480/2004(PAT.)

(51) Int. Cl. G02F 1/1335

(52) U.S. Cl. 349/102

(57) ABSTRACT

A liquid crystal display device capable of ensuring a good contrast ratio and preventing a lowering in color reproducibility at the time of motion picture image display includes a liquid crystal layer 56, showing optically uniaxial alignment, disposed between a first substrate B provided with at least a transparent electrode 54 and a second substrate A provided with an electrode 58 having a reflection function; a phase plate 52 disposed on the first substrate B; and a polarizer 51 disposed on the phase plate 52. The polarizer 51 and the phase plate 52 are disposed so that an optical axis of the polarizer 51 and a slow axis of the phase plate 52 form an angle θ, and the polarizer 51 and the liquid crystal layer 56 are disposed so that the optical axis of the polarizer 51 and an optical axis of the liquid crystal layer 56 form an angle of 2θ+45 degrees. A retardation of liquid crystal is changed in a range between λ/4 and λ/2 to prevent light passing during black display.

### FIELD OF THE INVENTION AND RELATED ART

The present invention relates to a liquid crystal display device, particularly a reflection-type liquid crystal display device which includes a liquid crystal disposed between a first substrate provided with at least a transparent electrode and a second substrate provided with an electrode having a reflection function.

With respect to conventional nematic liquid crystal display devices, active matrix-type liquid crystal display devices in which a plurality of active elements such as transistors (e.g., thin film transistors (TFTs)) are provided at pixels on a one-by-one basis have been developed. At present, as a mode of a nematic liquid crystal used in the active matrix-type liquid crystal display device, a twisted nematic (TN) mode described in M. Schadt and W. Helfrich, “Applied Physics Letters”, Vol. 18, No. 4, pp. 127-128 (published Feb. 15, 1971) has been used widely.

Further, in recent years, an In-Plane Switching mode utilizing a lateral-direction voltage has been proposed to improve a viewing angle characteristic which was disadvantage of the TN mode liquid crystal display device. There has also been proposed a super twisted nematic mode as a representative example of a nematic liquid crystal display device using no active elements (e.g., TFTs) described above.

Further, in 1983, Bos et al. have proposed a liquid crystal display device (P cell) in which a voltage is applied to a nematic liquid crystal disposed between a pair of electrode substrates so that alignment of the nematic liquid crystal is changed from splay alignment to bend alignment to improve a response time. In 1993, Uchida et al. have proposed a liquid crystal display device (OCB cell) in which the bend alignment cell is subjected to phase compensation to improve a viewing angle characteristic.

In addition, Japanese Laid-Open Patent Application (JP-A) No. Hei 06-337421 has proposed a one polarizer-type reflection type liquid crystal display device in which a liquid crystal cell which is provided with a λ/4 phase plate to have an electrically controlled birefringence (ECB) mode and includes a liquid crystal assuming substantially vertical bend alignment at the time of no voltage application and splay alignment at the time of voltage application is provided with a reflector but is not provided with a backlight.

Such a one polarizer-type reflection type liquid crystal display device is capable of effecting good black display and white display with respect to a light wavelength of approximately 550 nm showing a high luminosity factor but is accompanied with such a problem that the liquid crystal display device causes light passing (escape) during the black display and color deviation during the white display with respect to light wavelengths other than approximately 550 nm.

FIG. 8 shows a representative example of such a conventional liquid crystal display device 13, and a reflector 14. Referring to FIG. 8, external light enters from the left side of the polarizer 11 and passes through the polarizer 11 to enter a λ/4 phase plate 12 having a slow axis which is inclined 45 degrees with respect to a polarization axis (transparent axis) of the polarizer 11. The light passed through the phase plate 12 becomes circularly polarized light and then passes through the liquid crystal panel 13 to reach the reflector 14. Incidentally, in FIG. 8, a reference numeral 15 represents a moving (travelling) direction of the incident light.

The liquid crystal panel 13 changes a retardation depending on a voltage applied thereto. When the retardation is 0, light is not affected by the liquid crystal, so that the light is reflected by the reflector 14 to be returned to the phase plate as circularly polarized light which is laterally inverted. The returned light passes through the phase plate 12 as linearly polarized light with plane of polarization which is inclined 90 degrees with respect to the polarization axis. Immediately before the polarizer 11, the plane of polarization of the light is inclined 90 degrees from the original plane of polarization, so that the light does not pass through the polarizer to provide a dark (black) state.

In order to produce a bright state, the liquid crystal panel 13 is supplied with a voltage so as to act as a phase plate having an optical axis (slow axis) which is inclined 90 degrees with respect to the slow axis of the phase plate 12, and a retardation thereof is set to λ/4. A phase of the light incident from the polarizer 11 and changed into circularly polarized light by being passed through the λ/4 phase plate 12 which is inclined 45 degrees is deviated 90 degrees in an opposite direction during passing thereof through the liquid crystal panel 13, so that the light is changed to the original linearly polarized light. The plane of polarization is in a direction of the transmission axis of the polarizer. The light which is reflected by the reflector 14 and returned to the liquid crystal panel 13 passes through the liquid crystal panel 13 and the phase plate 12 but a phase difference is similarly cancelled, so that the light becomes the original linearly polarized light and passes through the polarizer 11.

As described above, in the reflection-type liquid crystal display device shown in FIG. 9, a black display state is formed when the retardation of the liquid crystal layer of the liquid crystal panel 13 is 0 nm.

In many cases, the phase plate is designed to provide an optimum characteristic with respect to green light with a wavelength of 550 nm. However, the phase plate generally has a wavelength dependency of a retardation characteristic with respect to a voltage. As a result, a complete black state is not obtained only with respect to light with a wavelength of 550 nm and light with other wavelengths is leaked from the phase plate.

FIG. 9 shows a relationship between a wavelength and a reflectance of the liquid crystal display device in the black state. As apparent from FIG. 9, the reflectance of light with wavelengths other than 550 nm is not 0%. For this reason, there arises such a problem that the reflectance during the black display is increased to fail to increase a contrast ratio.

In order to solve the problem, such a constitution that a liquid crystal panel which is provided with a polarizer, a first phase plate having a phase difference of λ/2. A second phase plate having a phase difference of λ/4 and includes a liquid crystal changed in alignment between homogeneous alignment (retardation: λ/4) and homeotropic (vertical) alignment (retardation: 0) is disposed on a reflector has been proposed in JP-A 2001-66598.

On the basis of the transmission axis of the polarizer, a slow axis of the first (λ/2) phase plate is inclined θ, and a low axis of the second (λ/4) phase plate and a low axis of the liquid crystal panel in which the liquid crystal is placed in the homogeneous alignment are substantially in parallel with each other and are inclined 2θ+45 degrees with respect to the basis axis. As a result, when the liquid crystal assumes the homeotropic alignment and the retardation thereof is 0, the dark state is obtained. When the liquid crystal assumes the homogeneous alignment and the retardation thereof is λ/4, the bright state is obtained.

However, the conventional liquid crystal display device utilizing the homogeneous alignment or the homeotropic alignment has a low response speed at the time when a display state is changed from a certain gradation display state to another halftone display state. For this reason, particularly, in a liquid crystal display device which effects color display by interference without using a color filter, a color different from an objective color is displayed during response of liquid crystal director. For this reason, a good contrast ratio cannot be ensured and there arises such a problem that a color reproducibility is lowered particularly in a motion picture display state.

### SUMMARY OF THE INVENTION

The present invention has accomplished in view of the above described problems.

An object of the present invention is to provide a liquid crystal display device capable of ensuring a good contrast ratio and preventing a lowering in color reproducibility during motion picture image display.

According to the present invention, there is provided a liquid crystal display device, comprising:
a transparent first substrate,
a second substrate provided with a reflector,
a phase plate, disposed on the first substrate, having a retardation of λ/2,
a polarizer disposed on the phase plate, and
a liquid crystal, disposed between the first and second substrates, having an optical axis exhibiting a uniaxial anisotropy in a substrate plane,
wherein when an angle between an optical axis of the polarizer and a slow axis of the phase plate is taken as θ, an angle between the optical axis of the polarizer and the optical axis of the liquid crystal is 2θ+45 degrees and the retardation of the liquid crystal is changed in a variable range from λ/4 to λ/2.

In the liquid crystal display device of the present invention, a liquid crystal assuming optically uniaxial alignment is disposed between the first substrate and the second substrate.

Further, when an angle between an optical axis of the polarizer and a slow axis of the liquid crystal is taken as θ, an angle between the optical axis of the polarizer and the optical axis of the liquid crystal is 2θ+45 degrees and the retardation of the liquid crystal is changed in a variable range from λ/4 to λ/2. By doing so, it is possible to not only ensure a good contrast ratio but also prevent a lowering in color reproducibility during motion picture image.

### BRIEF DESCRIPTION OF THE DRAWINGS

FIG. 1 is a principle explanatory view of a reflection-type liquid crystal display device according to the present invention.

FIG. 2 is an explanatory view of a polarization state in the liquid crystal display device.

FIG. 3 is a schematic view showing an example of a pixel constitution of the liquid crystal display device.

FIG. 4 is an explanatory view of a constitution of a liquid crystal display device according to the present invention.

FIG. 5 is a schematic view showing a TFT (thin film transistor) circuit constitution of the liquid crystal display device.

FIG. 6 is a graph showing a relationship between representative wavelengths and a reflection light intensity in an embodiment of the present invention.

FIG. 7 is a chromaticity diagram showing a change in color coordinate in the embodiment.

FIG. 8 is an explanatory view showing a representative constitution of a conventional reflection-type liquid crystal display device.

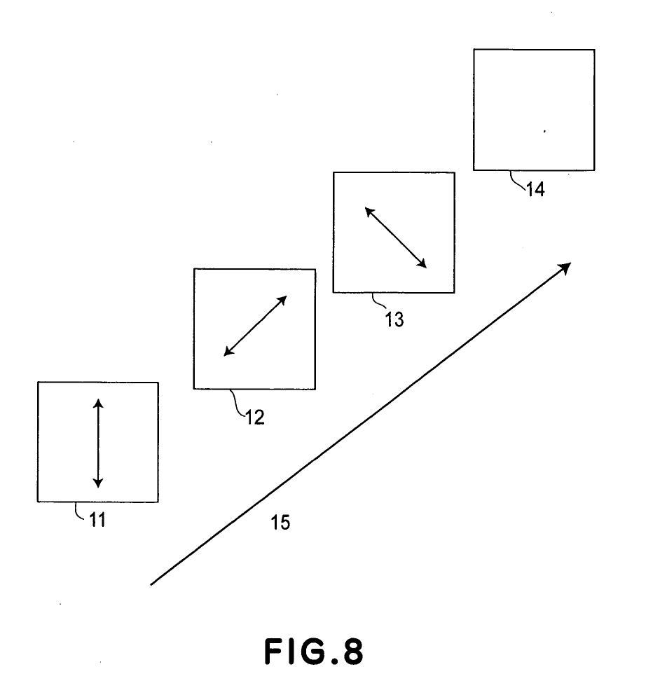

FIG. 9 is a graph showing a relationship between a wavelength and a reflectance in the conventional reflection-type liquid crystal display device.

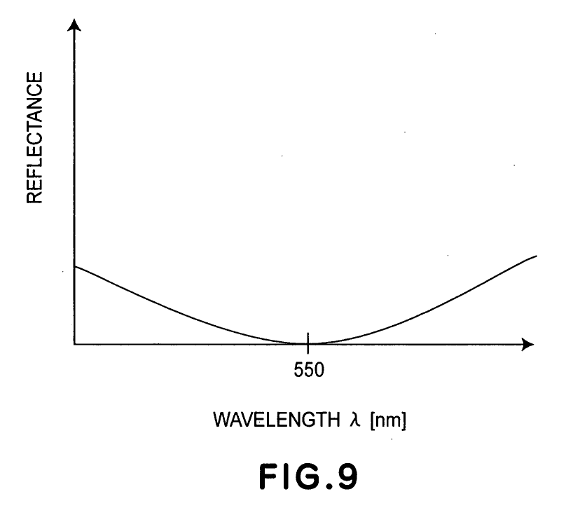

### DETAILED DESCRIPTION OF THE PREFERRED EMBODIMENTS

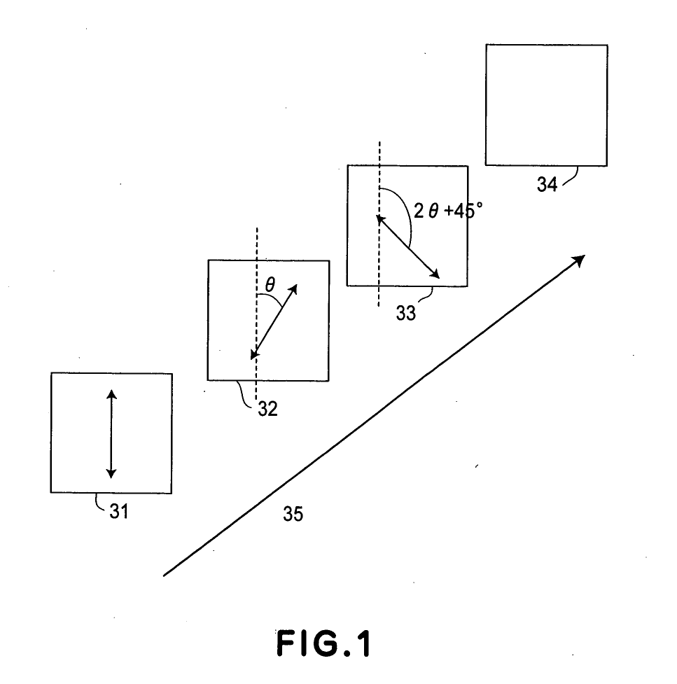

First, a basic principle of a reflection-type liquid crystal display device according to the present invention will be described with reference to FIG. 1.

Referring to FIG. 1, the liquid crystal display device includes a polarizer 31, a phase plate having a retardation of λ/2 and a slow axis which is fixed in a direction with an angle θ with respect to an optical axis of the polarizer 31, a liquid crystal panel 33, and a reflector 34.

The liquid crystal panel 33 includes a transparent first substrate, a second substrate provided with a reflection layer, and a liquid crystal disposed between the first substrate and the second substrate. At least one of the first and second substrates is subjected to a uniaxial aligning treatment, so that the liquid crystal disposed between the substrates is aligned to have an optical anisotropy. When a nematic liquid crystal is used, a resultant anisotropy is uniaxial.

A slow axis of the liquid crystal panel 33 in the present invention is fixed in a direction with an angle of 2θ+45 degrees with respect to the optical axis of the polarizer 31. Further, the liquid crystal panel 33 in the present invention switches a retardation depending on a voltage applied to the liquid crystal panel 33.

In the following description, an angle of the optical axis of the polarizer 31 is taken as a reference angle of 0 degrees. The optical axis may be a transmission axis or an absorption axis of the polarizer 31 but will be described hereinafter as the transmission axis.

A light wavelength λ is principally in the neighborhood of 550 nm at which a human luminosity (factor) is higher. However, when color display, e.g., utilizing a color filter is effected, the light wavelength is a representative wavelength of each of colors. Further, the λ/2 phase plate is a phase plate having a retardation of λ/2 and has a function of changing a phase of light with a wavelength of λ by p radian (180 degrees). The λ/4 phase plate changes the phase by λ/2 radian (90 degrees).

Here, in the above-constituted reflection-type liquid crystal display device, as shown in FIG. 1, external light with a wavelength of λ first enters the polarizer 31 in a direction of an arrow 35. The light passed through the polarizer 31 is changed to linearly polarized light with an angle of 0 degrees and enters the phase plate 32 having the retardation of λ/2.

The slow axis of the phase plate 32 is located at a position at an angle θ with respect to the optical axis of the polarizer 31. The light passed through the phase plate 32 is linearly polarized light inclined an angle 2θ with respect to the optical axis of the polarizer 31. The slow axis of the liquid crystal panel 33 is disposed at a position at an angle 2θ+45 degrees with respect to the optical axis of the polarizer 31, so that the slow axis of the liquid crystal panel 33 forms an angle of 45 degrees with respect to the polarization direction of the light passed through the phase plate 32.

In the case where the retardation of the liquid crystal panel 33 is set to λ/4, the light passed through the liquid crystal panel 33 is right circularly polarized light. The reflector 34 reflects the right circularly polarized light a left circularly polarized light. Thereafter, this reflection wave propagates in an opposite direction of the arrow 35.

The liquid crystal panel 33 passes the left circularly polarized light therethrough as linearly polarized light in the opposite direction of the arrow 35. A polarization direction of the linearly polarized light is 2θ+90 degrees.

The phase plate 32 changes the linearly polarized light to linearly polarized light with a polarization direction of 90 degrees. This polarization direction is just perpendicular to a transmission axis of the polarizer 31, so that an intensity of light finally emitted from the liquid crystal display device is 0, thus providing a black state.

On the other hand, in the case where the retardation of the liquid crystal panel 33 is λ/2, the light passed through the liquid crystal panel 33 is linearly polarized light with an angle 2θ+90 degrees with respect to the optical axis of the polarizer 31. Accordingly, the light reflected by the reflector 34 is the same polarized light as the incident light and passes through the phase plate 32 to be emitted from the polarizer 31. The emitted light at this time has a maximum intensity.

The above description is made with respect to a light switching behavior in the case where the wavelength of light is λ. However, in the case where the light has a wavelength other than λ, the light passed through the phase plate 32 and the liquid crystal panel 33 is elliptically polarized light. Next, a light switching behavior in the case where the light has a wavelength other than λ will be described from the viewpoint of ellipsometry.

Here, completely polarized light is represented by Stokes vector, and when Stokes vector is represented by polar coordinates, all the polarization states are located on a sphere having a radius of 1. This sphere is referred to as Poincare sphere” (“Applied Optics”, Ichiro YAMAGUCHI, issued by Ohmsha, Ltd.) Points on the equator of the Poincare sphere represent linearly polarized light. The longitude corresponds to twice the tangent angle of ellipticity (=minor axis/major axis) of elliptically polarized light, and the latitude corresponds to twice a polarization azimuth of linearly polarized light. The north pole represents right circularly polarized light and the south pole represents left circularly polarized light. When the point moves from the equator to the pole along the longitudinal line, the linearly polarized light is changed to circularly polarized light through elliptically polarized light. A change in polarization state by a uniaxial birefringence medium is explained by movement of the point on the sphere.

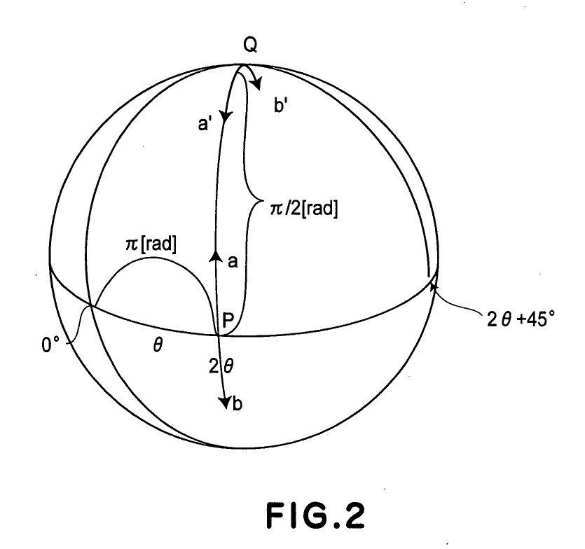

FIG. 2 is Poincare sphere showing a polarization state in the case where the retardation of the liquid crystal panel 33 is λ/4. The light, with a wavelength λ, passed through the polarizer 31 is linearly polarized light having an azimuth of 0 degrees, so that the light can be represented by a point on the equator at a latitude of 0 degrees. Then, when the light passes through the λ/2 phase plate 32, the light is rotated, from the point on the equator at the latitude of 0 degrees, on a circle with a center at a point of a latitude of 2θ corresponding to an angle θ of the phase plate 32 by p radian which is a phase difference of the phase plate 32, thus moving to a point (on the equator at a latitude of 4θ (point P shown in FIG. 2)) corresponding to linearly polarized light having an azimuth angle of 2θ. This means that the light passed through the phase plate 32 is changed to linearly polarized light with an azimuth angle of 2θ.

When the light passes through the liquid crystal panel 33 having the retardation of λ/4, the light rotated with a center at a point corresponding to an angle 2θ+45 degrees of the liquid crystal panel 33, i.e., a latitude 4θ+90 degrees on the equator by p/2 radian which is a phase difference of the liquid crystal panel 33 to be moved to a point Q, i.e., the north pole. This means that the light passed through the liquid crystal panel 33 is changed to right circularly polarized light. Further, the right circularly polarized light is changed to left circularly polarized light by the reflector 34. However, the light traveling direction is opposite to that of the right circularly polarized light, so that it is possible to consider that a phase state on the Poincare sphere is the north pole as it is. When the light passes through the liquid crystal 33, the light is further rotated by p/2 radian to be moved to a point on the equator at a latitude of 4θ+180 degrees, i.e., an opposite pole of P. then, the light is rotated by p radian by the phase plate (latitude=2θ). As a result, a point representing a phase state of the light is a point on the equator at a latitude of 180 degrees. This means that the light is changed to polarized light which is perpendicular to the incident light, so that the light passed through and emitted from the polarizer 31 has an intensity of 0, thus placing the liquid crystal display device in a black state.

Here, it is possible to place the liquid crystal display device in a good black state unless the point Q is moved therefrom even when the light has a wavelength other than λ. Hereinbelow, a change in polarization state when the light wavelength is somewhat deviated from λ will be considered.

Assuming that the light wavelength is somewhat longer than λ, a phase difference of the phase plate 32 is smaller than p radian, so that the point P is shifted in a direction toward a point a. However, when the light passes through the liquid crystal panel 33, a phase difference of the liquid crystal panel 33 is also smaller than p/2 radian as shown by a point a′ indicated in FIG. 2. As a result, it is possible to compensate an amount of deviation of the point Q.

Next, the case where the light wavelength is shorter than λ will be considered. In this case, the phase difference of the phase plate 32 is larger than p radian, so that the point P is shifted in a direction toward a point b. However, when the light passes through the liquid crystal panel 33, the phase difference of the liquid crystal panel 33 is also larger than p/2 radian as shown by a point b′ indicated in FIG. 2. Accordingly, it is also possible to compensate the amount of deviation of the point Q.

Based on these principles, even when the light has a wavelength other than p, the slow axis of the liquid crystal panel 33 can have an angle of 45 degrees with respect to the direction of linearly polarized light passed through the phase plate 32 by disposing the slow axis of the phase plate 32 at a position with an angle θ with respect to the optical axis of the polarizer 31 and disposing the slow axis of the liquid crystal panel 33 at a position with an angle 2θ+45 degrees with respect to the optical axis of the polarizer 31. Accordingly, the light passed through the liquid crystal panel 33 can retain circularly polarized light. As a result, it is possible to realize a good black state in a broad wavelength range and improve a contrast ratio.

Further, in a white display state, i.e., such a state that the retardation of the liquid crystal panel 33 is p/2, it is also possible to realize a good white display state, i.e., a display state in which a reflection intensity is not lowered even when the light has the wavelength other than p, on the basis of similar principles.

Incidentally, as a result of simulation, it has been clarified that the good white display (state) and the good black display (state) are in a trade-off relationship. More specifically, it has been clarified that the resultant display state is classified into the case where the black display state is good and the case where the white display state is good depending on a value of the angle θ.

For example, in the reflection-type liquid crystal display device, it is necessary to place prime importance on not only the black display state but also the white display state, e.g., in the case where a black character is displayed on a white background. Further, from this viewpoint, when a relationship between a wavelength transmittance characteristic during the white display and a wavelength transmittance characteristic during the black display is studied, it has been clarified that a good display state which is human eye-friendly is formed in the case where an angle θ between the slow axis of the phase plate 32 and the optical axis of the polarizer 31 is 22.5 degrees.

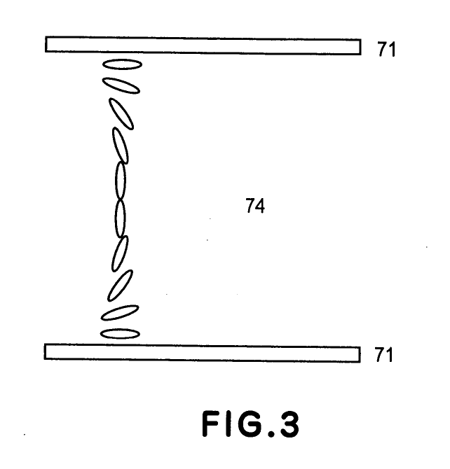

Further, with respect to liquid crystal alignment in the liquid crystal panel 33, it is possible to use the ECB mode. However, the present inventors have found that the liquid crystal alignment is further improved by using bend alignment as shown in FIG. 3 while focusing attention on the problem of the lowering in color reproducibility when motion picture display is effected in the above described color display mode using interference color. Here, the bend alignment includes not only alignment such that pretilt angles of upper and lower substrates 71 and 71 are equal to each other as shown in FIG. 3 but also asymmetrical alignment providing different pretilt angles. Further, it is also possible to employ such an alignment state that either one of the pretilt angles is 90 degrees, i.e., that a liquid crystal director 74 is perpendicular to the substrates 71.

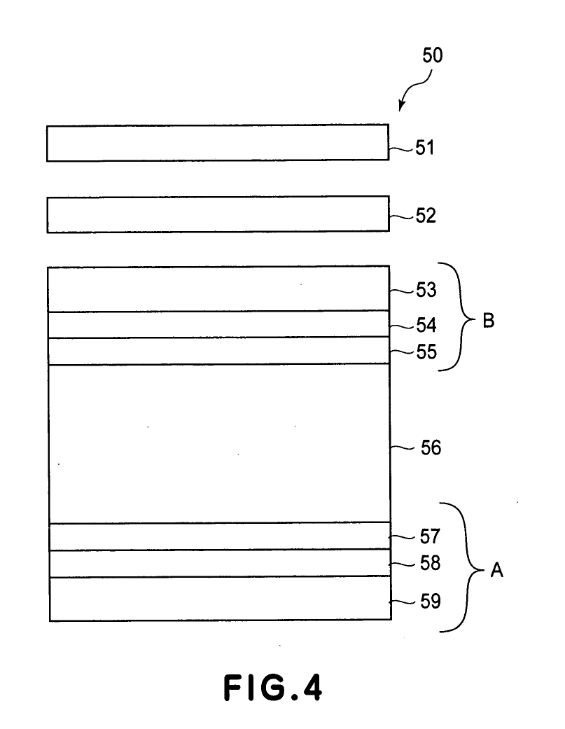

Next, a preferred embodiment of the reflection-type liquid crystal display device according to the present invention will be described with reference to FIG. 4.

As shown in FIG. 4, a reflection-type liquid crystal display device is constituted by a substrate B including a transparent substrate 53, a transparent electrode 54, and an alignment film 55; a substrate A including a substrate 59, a reflector electrode 58, and an alignment film 57; a liquid crystal layer 56 disposed between the two substrates A and B; a λ/2 phase plate 52 disposed on the substrate B; and a polarizer 51 disposed on the λ/2 phase plate 52.

In this embodiment, at least one of the transparent substrate 53 an the substrate 59 has been subjected to uniaxial aligning treatment. Incidentally, the λ/2 phase plate 52 may preferably have a retardation in a range of 220-280 nm. The liquid crystal layer 56 comprises a nematic liquid crystal as a liquid crystal material. The liquid crystal layer 56 may preferably have a retardation in a variable range including a range of 110-140 nm.

Incidentally, in the description of the basic principle with reference to FIG. 1, the liquid crystal panel and the reflector are explained as different members for the sake of simplicity. In this embodiment, however, in order to prevent parallax during oblique observation, the liquid crystal panel and the reflector are integrally formed by disposing on the substrate 59 the reflector electrode 58 constituted by a member, having a reflection characteristic, such as an aluminum electrode. Further, in the case of using the liquid crystal display device as a direct-view-type display device, it is also possible to use a diffusion reflector electrode having an uneven shape as the reflector electrode 58. Alternatively, a front scattering film (not shown) may be disposed on any one of the transparent substrate 53, the phase plate 52, and the polarizer 51.

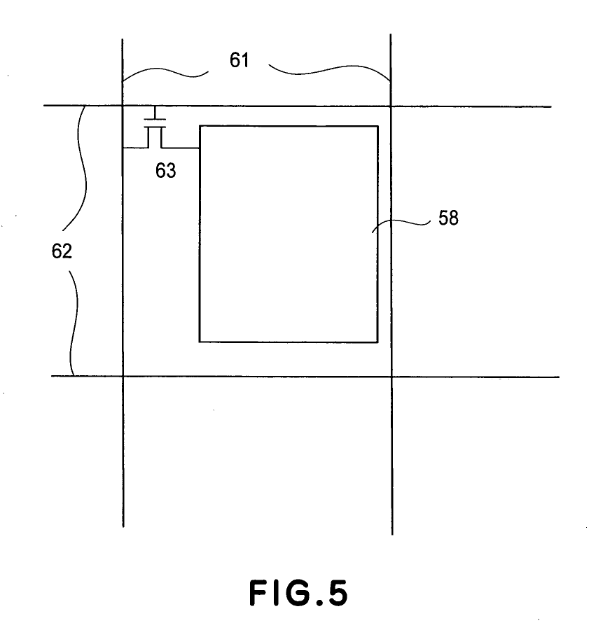

Further, as shown in FIG. 5, a TFT circuit for applying a voltage to the liquid crystal layer 56 may be disposed on the substrate 59. Further, in the case of a color display device, a color filter may be disposed on the substrate 53. In FIG. 5, the reflector electrode 58 is connected with a TFT 63 which is connected with a TFT 63 which is connected with a source line 61 and a gate line 62.

With respect to the color filter, sub pixels provided with color filters of red (R), green (G), and blue (B), respectively, may be formed and used for display by additive color mixture. It is also possible to form sub pixels provided with a G color filter and a magenta (M) color filter, respectively, and display of G is effected by the sub pixel provided with the G color filter and display of B is effected by the sub pixel provided with the M color filter on the basis of color display utilizing interference color.

In addition, it is also possible to use a combination of R and cyan (C), a combination of B and yellow (Y), and the like. Alternatively, it is also possible to effect display of three primary colors by displaying one color with the use of only one of the color filters of R, G, and B and displaying other two colors on the basis of color display utilizing interference colors.

As described above, in the liquid crystal display device which effects display by disposing the liquid crystal assuming uniaxial alignment between the first substrate B provided with at least the transparent substrate 53 and the second substrate A provided with the reflector electrode 58 having the reflection function and changing the retardation of the liquid crystal, the angle between the optical axis of the pixel 31 and the optical axis of the liquid crystal assuming uniaxial alignment is set to 2θ+45 degrees when the angle between the slow axis of the pixel 31 and the slow axis of the phase plate 32 is θ. As a result, the liquid passed through the liquid crystal panel 33 can retain circularly polarized light. Accordingly, a good black state can be realized in a broad wavelength range, so that it is possible to prevent light passing (escape) during the black display. As a result, it is possible to not only ensure a good contrast ratio but also prevent a lowering in color reproducibility during the motion picture image display.

Incidentally, in the present invention, the angle defined herein can provide a desired characteristic so long as it is substantially in a predetermined range even when it is not strictly coincident with the defined value. For example, with respect to the angle set at 2θ+45 degrees, the object of the present invention can be accomplished when the angle is within ±3 degrees with respect to 2θ+45 degrees.

### EXAMPLE

Hereinbelow, the present invention will be described more specifically based on an example.

In this example, first, 0.7 mm-thick glass substrate, an uneven portion is formed of a photosensitive resin (mfd. by Nissan Chemical Industries, Ltd.), and thereon, an insulating resin (“Optomer ss6699G”, mfd. by JSR Corp.) is applied by spin coating to form an insulating film.

Then, on the switching film, a 150 nm-thick Al film as a reflector electrode is formed to prepare a reflector electrode substrate A having a scattering characteristic (FIG. 4). Incidentally, it is also possible to use a silicone substrate, a plastic substrate, etc., in place of the glass substrate.

On a 0.7 mm-thick glass substrate, a 150 nm-thick transparent electrode of ITO (indium tin oxide) is formed to prepare a substrate B (FIG. 4). In place of the glass substrate, it is also possible to use a transparent plastic substrate or the like.

Onto each of the above prepared substrates A and B, a polyimide resin (JALS 2022″, mfd. by JSR Corp.) is applied by spin coating and pre-dried at 80° C. for 5 min., followed by hot backing at 200° C. for 1 hour to form a 50 nm-thick polyimide alignment film.

Each of the polylmide alignment films formed on the substrates A and B is subjected to rubbing treatment with a nylon cloth as uniaxial aligning treatment. The rubbing treatment is performed by using a rubbing roller prepared by using a rubbing roller prepared by applying a nylon film “NF-77”, mfd. by Teijin, Ltd.) onto a 10 cm-dia. roller under conditions including a pressing depth of 0.5 mm, a feeding speed of 10 cm/sec, a rotation speed of 1000 rpm, and the number of feeding of 3.

On one of the substrates A and B, silica beads having an average particle size of 9 μm as a spacer are spread, and the substrates A and B are disposed opposite to each other, so that their rubbing directions are in parallel with each other. Between the substrates A and B, a commercially available liquid crystal (“KN 5027”, mfd. by Chisso Corp.) is injected to obtain a liquid crystal cell.

Onto the substrate B of the thus prepared liquid crystal cell, a polycarbonate film having a retardation of 275 nm is applied as a λ/2 phase plate. On the λ/2 phase plate, a polarizer is disposed to prepare a reflection-type liquid crystal display device.

In the liquid crystal display device, an optical axis of the polarizer and slow axes of the λ/2 phase plate and the liquid crystal cell are arranged as follows.

The slow axis of the λ/2 phase plate is located at a position with an angle of 22.5 degrees in a clockwise direction with respect to the optical axis of the polarizer, and the slow axis of the liquid crystal cell is located at a position with an angle of 90 degrees in a clockwise direction with respect to the optical axis of the polarizer. These slow axes of the λ/2 phase plate and the liquid crystal cell may also be located at positions with an angle of 22.5 degrees and an angle of 90 degrees, respectively, in a counterclockwise direction with respect to the optical axis of the polarizer. A pretilt angle is 10 degrees.

The liquid crystal in the liquid crystal cell originally assumes splay alignment as liquid crystal alignment but is readily caused to assume bend alignment by applying a voltage of about 10 between the reflector electrode and the transparent electrode. The bend alignment is held when the voltage applied between the electrodes is not less than 2 V. Further, when the voltage is applied, a retardation is changed in a range of 110-450 nm.

In such a reflection-type liquid crystal display device, when a voltage of about 3.45 V is applied between the reflector electrode and the transparent electrode, the retardation of the liquid crystal cell is 275 nm. At this time, a resultant intensity of reflected light is a maximum value. Further, when a voltage of about 6.3 V is applied, the retardation of the liquid crystal cell is 137.5 nm and a resultant intensity of reflected light is a minimum value.

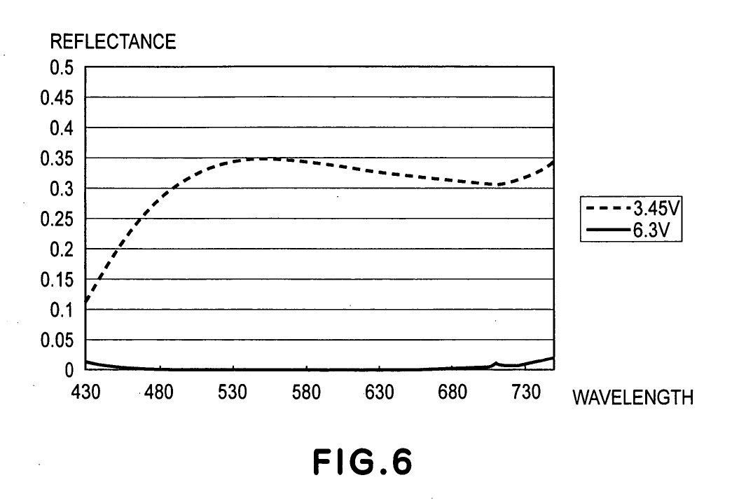

FIG. 6 is a graph showing a relationship between representative wavelengths and intensities of reflected light in this example. As apparent from FIG. 6, the reflected light intensity at 3.45 V shows a moderate characteristic in the entire visible wavelength range, thus allowing white display with no color deviation. On the other hand, the reflected light intensity at 6.3 V is considerably smaller than that at 3.45 V. As a result, it is found that a resultant contrast ratio is high.

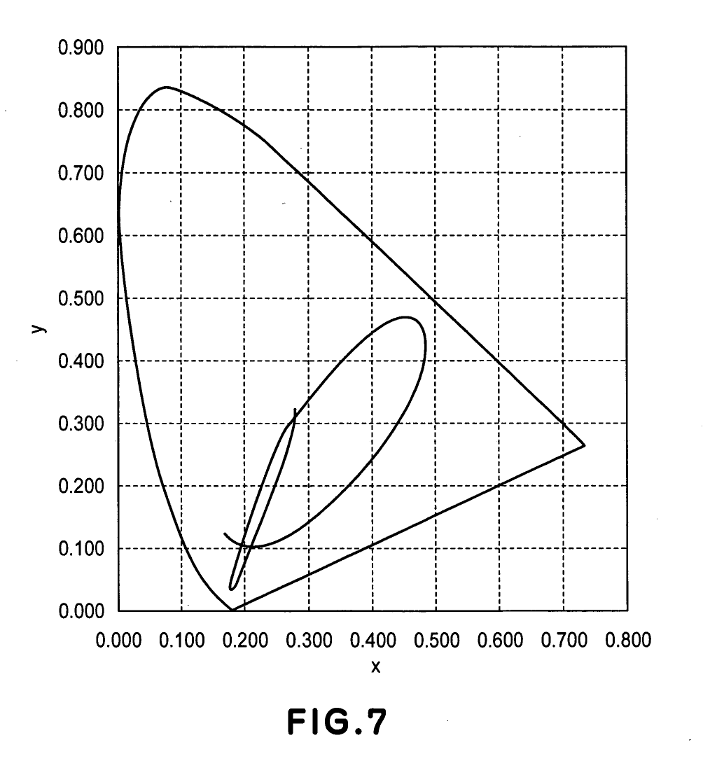

FIG. 7 is a chromaticity diagram showing chromaticity coordinates of the reflected light when the applied voltage is changed in a range of 2-6.3 V. From FIG. 7, it is found that red display can be effected at about 2.7 V and blue display can be effected at about 2 V. Incidentally, in order to increase a color purity during the red display, a color filter of magenta may also be disposed. Further, during green display, a color filter of green may also be disposed under application of a voltage in a range of 3.45-6.3 V.

In this example, a response time (speed) of the reflected light intensity during switching from the white display to the black display and switching from the black display and the white display is several milli-seconds to ten and several milli-seconds, thus being very small. As a result, it is possible to suppress a lowering in color reproducibility during motion picture image display.

As described above, according to the present invention, it is possible to provide a reflection-type liquid crystal display device which is inexpensive and suitable for motion picture image display while preventing light escape during the black display and ensuring a good contrast ratio.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 273480/2004 filed Sep. 21, 2004, which is hereby incorporated by reference.

What is claimed is:

1. A liquid crystal display device, comprising:
a transparent first substrate,
a second substrate provided with a reflector,
a phase plate, disposed on said first substrate, having a retardation of λ/2,
a polarizer disposed on said phase plate, and
a liquid crystal, disposed between said first and second substrates, having an optical axis exhibiting a uniaxial anisotropy in a substrate plane,
wherein when an angle between an optical axis of said polarizer and a slow axis of said phase plate is taken as θ, an angle between the optical axis of said polarizer and the optical axis of said liquid crystal is 2θ+45 degrees and the retardation of said liquid crystal is changed in a variable range from λ/4 to λ/2.

2. A device according to claim 1, wherein the retardation of said phase plate is in a range of 220-280 nm, and the variable range of the retardation of said liquid crystal contains a range of 110-140 nm.

3. A device according to claim 1, wherein said liquid crystal is a nematic liquid crystal showing bend alignment.

4. A device according to claim 1, wherein the angle θ is 22.5 degrees.

5. A device according to claim 1, wherein said liquid crystal exhibits birefringence so as to produce interference color to effect color display.
